(19) United States
(12) Patent Application Publication
(10) Pub. No.: US 2025/0173770 A1
(43) Pub. Date: May 29, 2025

(54) ARTIFICIAL INTELLIGENCE QUOTATION SYSTEM

(71) Applicants: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/522,256

(22) Filed: Nov. 29, 2023

(51) Int. Cl. G06Q 30/0601; G06Q 30/0201

(52) U.S. Cl. CPC G06Q 30/0611; G06Q 30/0206

(57) ABSTRACT

An artificial intelligence quotation system includes an internet equipment; a processing unit that is matched with the internet equipment. The internet equipment includes a central processor, an artificial intelligence software, a quotation software and a database. The quotation software includes quotation service objectives which include a quoting, a diverse service, a transportation route, a real-time data, a visualization and comparison tool, an automated quoting, a security, and a compliance. The central processor drives the artificial intelligence software which receives input data, and the artificial intelligence software searches data through the internet equipment and calculates a final quotation and provides services. The database stores historical query data from the artificial intelligence software.

### BACKGROUND OF THE INVENTION

### Fields of the Invention

The present invention relates to an artificial intelligence quotation system, and more particularly, to a system that receives customer inquiry data and calculates quotations using artificial intelligence.

### Descriptions of Related Art

International import and export of goods are quite complex, involving the processing of import and export documents, payment of tariffs, customs clearance, insurance, and cargo tracking. Therefore, when businesses engage in the import and export of goods, it is a common choice to collaborate with freight forwarders (shipping agents).

However, the international freight forwarding industry is currently highly competitive, and traditional manual quotation and operation methods are not only costly but also inefficient. Especially in terms of customer inquiries, freight forwarders face many challenges arising from the complexity of the industry and market uncertainties. Common problems include complex rate structures, diverse types of goods, constantly changing markets, diverse destinations and routes, varied customer demands, manual processing, data inconsistency, regulations and compliance, competitive markets, and customer loyalty, among others.

Given the above issues, if the current market continues to rely on traditional human labor for customer inquiries and quotations, maintaining competitiveness would require investing more manpower resources. However, the increasing cost associated with more manpower could gradually erode the company's profits, making it difficult to survive in the market. Therefore, there is a need to improve the traditional quotation methods for customer inquiries.

The present invention intends to provide an artificial intelligence quotation system that eliminates the shortcomings mentioned above.

### SUMMARY OF THE INVENTION

The present invention utilizes a processing unit that includes artificial intelligence software. It uses artificial intelligence to process customer inquiry data, combining it with network data based on reasonable objectives. The system intelligently calculates the final quotation, eliminating the dependence on human labor in the process. Compared to the traditional method of freight forwarders manually handling customer inquiries, the present invention can significantly save operational costs, effectively addressing the human labor costs associated with traditional freight forwarders handling customer inquiries.

The present invention relates to an artificial intelligence quotation system and includes an internet equipment; a processing unit that is matched with the internet equipment. The internet equipment includes a central processor, an artificial intelligence software, a quotation software and a database. The quotation software includes quotation service objectives which include a quoting, a diverse service, a transportation route, a real-time data, a visualization and comparison tool, an automated quoting, a security, and a compliance. The central processor drives the artificial intelligence software which receives input data, and the artificial intelligence software searches data through the internet equipment and calculates a final quotation and provides services. The database stores historical query data from the artificial intelligence software.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the operation of the artificial intelligence quotation system of the present invention.

### DETAILED DESCRIPTION OF THE PREFERRED EMBODIMENT

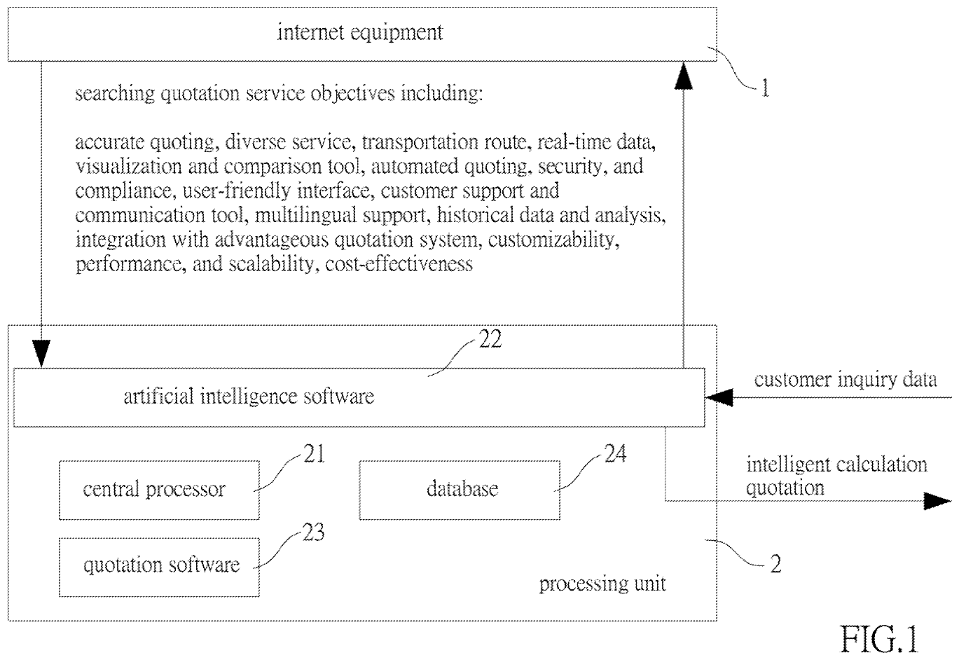

Referring to FIG. 1, the artificial intelligence quotation system of the present invention comprises an internet equipment 1 and a processing unit 2 that is matched with the internet equipment 1. The processing unit 2 includes a central processor 21, an artificial intelligence software 22, a quotation software 23 and a database 24. The quotation software 23 includes quotation service objectives which include an accurate quoting, a diverse service, a transportation route, a real-time data, a visualization and comparison tool, an automated quoting, a security, and a compliance. The central processor 21 drives the artificial intelligence software 22, and the artificial intelligence software 22 receives input data. The artificial intelligence software 22 searches data through the internet equipment 1 and calculates a final quotation and providing services. The database 24 stores a historical query data from the artificial intelligence software 22.

The processing unit 2 of the present invention can be a microcomputer, server, etc. The ways in which the processing unit 2 receives customer data and responds with quotations can include through the internet, matching mobile app software, etc.

The quotation software 23 includes quotation service objectives which further include a user-friendly interface, a customer support and communication tool, a multilingual support, a historical data and analysis, an integration with other systems (integration with advantageous quotation systems), a customizability, a performance and scalability, and a cost-effectiveness.

### Further Details on the Reasons for Each Quotation Service Objective:

Accurate Quoting: The system provides accurate freight and related cost quotations, taking into account factors such as the type of goods, weight, volume, mode of transportation, destination, and other factors. This helps freight forwarder companies provide transparent and reliable quotations to customers.

Diverse Services and Routes: The system supports various types of goods, transportation modes (such as air, sea, land), and international shipping routes. This allows freight forwarder companies to meet the diverse needs of different customers.

Real-time Data: Due to significant fluctuations in freight market prices, the system provides real-time updated data to reflect market changes. This includes fuel surcharges, tariffs, exchange rates, etc.

Visualization and Comparison Tools: The system provides visualization tools for users to compare different transportation options, costs, and delivery times. This helps customers make informed decisions.

Automated Quoting: The system is able to automatically generate quotations, reducing manual work. This will improve efficiency and reduce errors.

Security and Compliance: When handling sensitive freight data, the system must ensure security and compliance. This includes data encryption, access control, and compliance with international and local regulations.

User-friendly Interface: The system's user interface is easy to use, allowing employees and customers of freight forwarder companies to navigate and use the system easily.

Historical Data and Analysis: The system is able to store historical data and provide analysis tools to help freight forwarder companies make better business decisions.

Customer Support and Communication Tools: The system provides tools for communicating with customers, including online chat, email notifications, etc., to answer customer questions and provide support.

Multilingual Support: Considering that international freight involves various countries and regions, the system should provide multilingual support to facilitate global customers.

Integrating Other Systems: The system is able to integrate with other freight management systems, logistics tracking systems, etc., to achieve seamless process connections.

Customizability: The system has a certain degree of customizability to meet the unique needs and brand identity of different freight forwarding companies.

Performance and Scalability: The system has good performance and scalability to address the growing business demands.

Cost-effectiveness: The development and maintenance costs of the system is reasonable to bring significant benefits to freight forwarding companies.

The present invention utilizes a processing unit 2 containing artificial intelligence software 22. It processes customer inquiry data through artificial intelligence based on reasonable objectives, combining it with network data. The system intelligently calculates the final quotation and related services (such as providing a more user-friendly operating interface, comparison tools, etc.). This entire process no longer relies on human labor, making it more cost-effective compared to the traditional method of freight forwarders manually handling customer inquiries. The invention is innovative and progressive.

The present invention provides freight forwarding companies with intelligent quoting, resulting in more satisfying services for customers, such as:

Improved Efficiency: The international freight forwarding industry involves a large amount of complex information and calculations, including different types of goods, transportation modes, destinations, etc. The artificial intelligence system can quickly and accurately process this information, improving the speed and accuracy of quotations, saving time and labor costs.

Accurate Quoting: The artificial intelligence system can provide accurate freight cost quotations based on historical data and real-time information. This helps freight forwarding companies provide transparent and reliable quotations, enhancing customer satisfaction.

Meeting Customer Needs: Customers often require different transportation options, prices, and delivery times. The artificial intelligence system can provide diverse services and routes, helping customers choose the solution that best fits their needs.

Market Competitiveness: By using the artificial intelligence system, freight forwarding companies can better compete with rivals. The ability to quickly respond to customer demands and provide competitive quotations enhances the company's market competitiveness.

Automated Processing: The artificial intelligence system can automate the generation of freight quotations, reducing manual operations and lowering the risk of errors. This improves the efficiency of the overall business process.

Real-time Data: The international freight market experiences significant price fluctuations, requiring timely updates. The artificial intelligence system can provide real-time price and cost information, helping companies better adapt to market changes.

Customer Satisfaction: By providing accurate and efficient quotations, freight forwarding companies can increase customer satisfaction, strengthen customer loyalty, and gain more business.

Globalization Demand: International freight involves different countries and regions, each with its own regulations and market conditions. The artificial intelligence system can generate quotations based on the specific requirements of different countries and regions.

Reducing Human Errors: Manual processing of freight quotations is prone to errors, such as calculation mistakes or information omissions. The artificial intelligence system can significantly reduce the risk of these human errors.

Competitive Advantage: Introducing an artificial intelligence system can help freight forwarding companies gain a competitive advantage by providing better services and attracting more customers.

While we have shown and described the embodiment in accordance with the present invention, it should be clear to those skilled in the art that further embodiments may be made without departing from the scope of the present invention.

What is claimed is:

1. An artificial intelligence quotation system comprising:
an internet equipment (1);
a processing unit (2) matched with the internet equipment (1), the processing unit (2) including a central processor (21), an artificial intelligence software (22), a quotation software (23) and a database (24);
the quotation software (23) including quotation service objectives which include a quoting, a diverse service, a transportation route, a real-time data, a visualization and comparison tool, an automated quoting, a security, and a compliance;
the central processor (21) driving the artificial intelligence software (22), the artificial intelligence software (22) receiving input data, the artificial intelligence software (22) searching data through the internet equipment (1) and calculating a final quotation and providing services, and
the database (24) storing historical query data from the artificial intelligence software (22).

2. The artificial intelligence quotation system as claimed in claim 1, where the quotation service objectives of the quotation software (23) include an interface, a customer support and communication tool and a multilingual support.

3. The artificial intelligence quotation system as claimed in claim 1, where the quotation service objectives of the quotation software (23) include a historical data and analysis.

4. The artificial intelligence quotation system as claimed in claim 1, where the quotation service objectives of the quotation software (23) include an integration with advantageous quotation system.

5. The artificial intelligence quotation system as claimed in claim 1, where the quotation service objectives of the quotation software (23) include customizability, performance, and scalability.

6. The artificial intelligence quotation system as claimed in claim 1, where the quotation service objectives of the quotation software (23) include cost-effectiveness.
